(19) United States
(12) Patent Application Publication
(10) Pub. No.: US 2006/0065579 A1
(43) Pub. Date: Mar. 30, 2006

(54) Automatic leak responsive valve

(75) Inventor: Warren Thomson, Pewaukee, WI (US)

Correspondence Address: DONALD J. LENKSZUS, PO BOX 3064, CAREFREE, AZ, 85377-3064, US

(73) Assignee: BMW PARKWAY LLC, TEMPE, AZ (US)

(21) Appl. No.: 10/950,358

(22) Filed: Sep. 24, 2004

(51) Int. Cl. B01D 65/00

(52) U.S. Cl. 210/97; 210/321.6; 251/12; 251/66

(57) ABSTRACT

In accordance with the principles of the invention, an automatic shut-off valve is provided for use with a fluid utilization device. The valve automatically cuts off water to the utilization device should the utilization device develop a leak. In an illustrative embodiment of the invention, the valve includes a valve assembly having a valve body, an inlet port, an outlet port, and a valve member movable between first and second positions, and an element biasing the valve member to the second position. An actuator is coupled to the valve. The actuator comprises a fluid responsive member coupled to the element to maintain the valve member in the first position in the absence of fluid. The fluid responsive member becomes weakened in the presence of the fluid such that the fluid responsive member is severed thereby releasing the actuator such that the valve member automatically moves to the second position.

### FIELD OF THE INVENTION

This invention pertains to fluid handling devices, in general, and to an automatically operated leak detection valve, in particular.

### BACKGROUND OF THE INVENTION

A commonly occurring problem in plumbing systems is leakage. Leakage, if unchecked, can result in water damage, and other problems related to excessive unintended moisture.

Leak detection arrangements have been developed in the past. Typically such leak detection arrangements utilize electricity either in the sensor, or in the operation of a sensor responsive apparatus that operates a valve. Often, solenoid type valves are utilized.

One problem with prior leak detection arrangements is that in the event of a loss of power, the leak detection arrangement becomes inoperable. For battery operated systems, the battery typically has a finite life after which the system may become unresponsive or unreliable.

An additional problem is that arrangements that utilize electronic control or electromechanical devices are relatively expensive.

It desirable to provide a leak detecting valve arrangement that is simple, reliable and inexpensive.

### SUMMARY OF THE INVENTION

In accordance with the principles of the invention, an automatic shut-off valve is provided for use with a water utilization device. The valve automatically cuts off water to the utilization device should the utilization device develop a leak. In an illustrative embodiment of the invention, the valve includes a valve assembly having a valve body, an inlet port, an outlet port, and a valve member movable between first and second positions, and an element biasing the valve member to the second position. An actuator is coupled to the valve. The actuator comprises a fluid responsive member coupled to the element to maintain the valve member in the first position in the absence of fluid. The fluid responsive member becomes weakened in the presence of fluid so as to change its physical shape from a first or dry shape to a second or wet shape. In one embodiment of the invention the fluid responsive member responds to the presence of the fluid such that the fluid responsive member is severed thereby releasing the actuator such that the valve member automatically moves to the second position.

A water purification system in accordance with the principles of the invention includes a reverse osmosis system having an inlet coupleable to a water source; and an automatic shut off valve disposed between the reverse osmosis system and the water source. The automatic shutoff valve in one illustrative embodiment comprises a valve assembly having a valve body, an inlet port, an outlet port, and a valve member movable between first and second positions, and an element biasing the valve member to the second position. The system of the illustrative embodiment further includes an actuator coupled to the valve. The actuator retains the valve in the first position in opposition to force provided by the biasing element. The actuator comprises a fluid responsive member coupled to the biasing element to maintain the valve member in the first position in the absence of fluid. In the illustrative embodiment, the fluid responsive member is weakened in the presence of water such that the fluid responsive member is severed thereby releasing the actuator such that the valve member automatically moves to the second position thereby preventing further flow of water from the water source.

Still further in accordance with the principles of the invention, a leak control arrangement is provided which comprises a valve assembly comprising a valve movable between a first state and a second state, a bias element for exerting a first force urging the valve to the second state, and a fluid responsive member coupled to the valve and acting to restrain the valve in the first state in opposition to the first force. The fluid responsive member, when dry, retains the valve in the second state and when wet becomes weakened and physically changes to thereby allow the bias element to move the valve from the first position to the second position.

In the illustrative embodiment of the invention a holding element is adapted to hold the fluid responsive member in proximity to a fluid leak collection area.

In the illustrative embodiment the fluid responsive member comprises a strip. The strip becomes weakened in the presence of fluid, and the first force is at a level such that when the strip becomes weakened, the first force is sufficient to cause the weakened strip to separate.

In the illustrative embodiment of the invention the valve is a lever actuated valve. The bias member comprises a spring coupled to the lever.

Still further in accordance with an aspect of the invention a holding apparatus is adapted to retain the fluid responsive member in proximity to a fluid collection area.

It will be appreciated by those skilled in the art that the principles of the invention apply to detecting the presence of various kinds of fluids. The principles of the invention are advantageously applicable to water utilization devices including a water conditioning system, a reverse osmosis unit, a water heater, a washing machine, a boiler, a hot water heating system and any other water utilization devices, systems and apparatus.

### BRIEF DESCRIPTION OF THE DRAWING

The invention will be better understood from a reading of the following detailed description of preferred embodiments of the invention in conjunction with the drawing figures in which the sizes of and distances between various elements is not representative of actual physical sizes or distances between various elements and in which like designators are used to identify like or similar elements, and in which directional orientations are not intended to be limiting, and in which:

FIG. 1 illustrates apparatus in accordance with the principles of the invention;

FIG. 2 illustrates the apparatus of FIG. 1 with the valve of FIG. 1 shut off;

FIG. 3 is a side view of the arrangement of FIG. 1;

FIG. 4 illustrates a component of the valve shown in FIG. 1;

FIG. 5 illustrates a detail of a portion of the valve show in FIG. 4;

FIG. 6 illustrates details of a portion of the arrangement of FIG. 1;

FIG. 7 is a top view of a second component of the arrangement of FIG. 1;

FIG. 8 illustrates a valve, in accordance with the principles of the invention in an open or first state; and

FIG. 9 illustrates the valve of FIG. 8 in a closed or second state.

### DETAILED DESCRIPTION

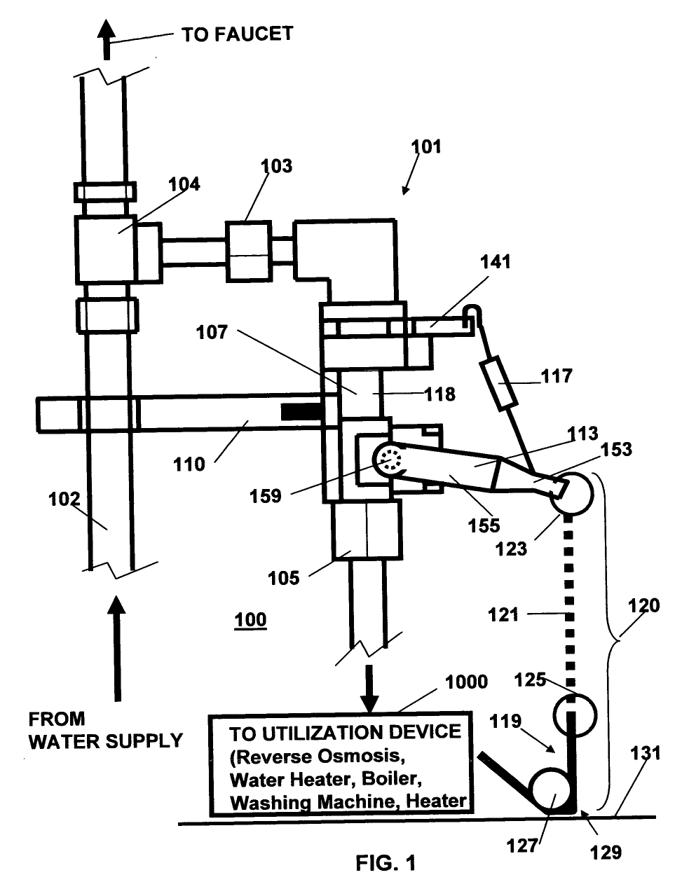

FIG. 1 shows apparatus 100 in accordance with the principles of the invention. The apparatus 100 of the illustrative embodiment is utilized with a reverse osmosis unit which is not shown, but which is indicates as a water-utilization device. The principles of the invention are equally applicable to any other water utilization device, including, but not limited to a water conditioning system, a water heater, a washing machine, a boiler, a hot water heating system and any other water utilization devices, systems and apparatus. Apparatus 100 is likewise particularly well suited for applications such as in rental properties or multi-story buildings where unattended leaks of water utilization devices, systems and apparatus can lead to damage as well as creation of environments in which microorganisms may become established.

Apparatus 100 include a valve assembly 101 having an inlet port 103 and an outlet port 105. Inlet port 103 is coupled to a water source or water supply via a water line or conduit 102. In the illustrative use of apparatus 100 with a reverse osmosis unit, water line 102 continues on to a faucet. A saddle valve 104 is used to couple the reverse osmosis unit or water utilization device to water line 102. Valve assembly 101 is disposed upstream of and in the water supply path to the reverse osmosis unit or water utilization device. Valve assembly 101 is attached to and supported in position by support member 110, which is affixed to valve assembly 101 and clamped to water line 102.

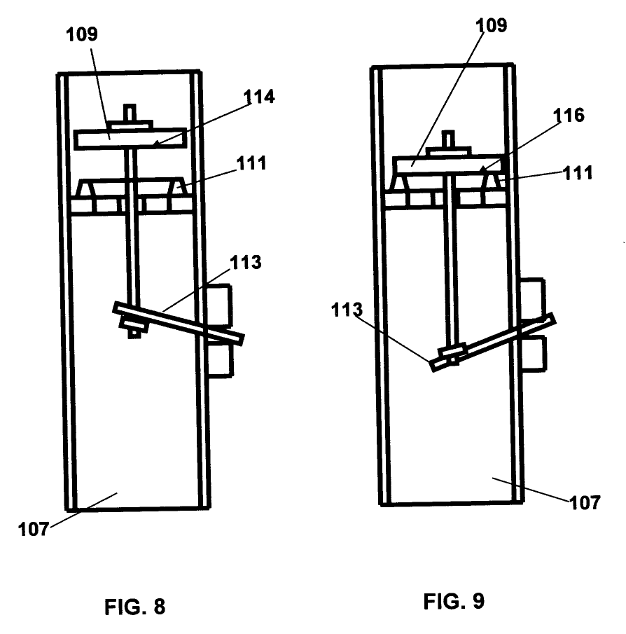

Valve assembly 101 includes a valve body 107 that contains a movable valve member 109 and a valve seat 111 which are most clearly seen in FIGS. 8 and 9. A lever 113 is utilized to move valve member 109 between a first or open position 114 and a second or closed position 116.

Valve assembly 101 includes a bias member or element or spring 117 that acts on the valve member 109 to urge valve member 109 to the second or closed position. Spring 117 is coupled to the body 118 of valve assembly 101 and to lever 113. Lever 113 is coupled to valve member 109 to move valve member 109 between first and second positions.

An actuator 120 is coupled to the valve assembly 101. Actuator 120 comprises fluid responsive member 119, retaining member 127, and a linkage comprising chain 121 and coupling rings 123 and 125. Retaining member 127 retains one portion 129 of fluid responsive member 119 in proximity to a leakage collection surface 131.

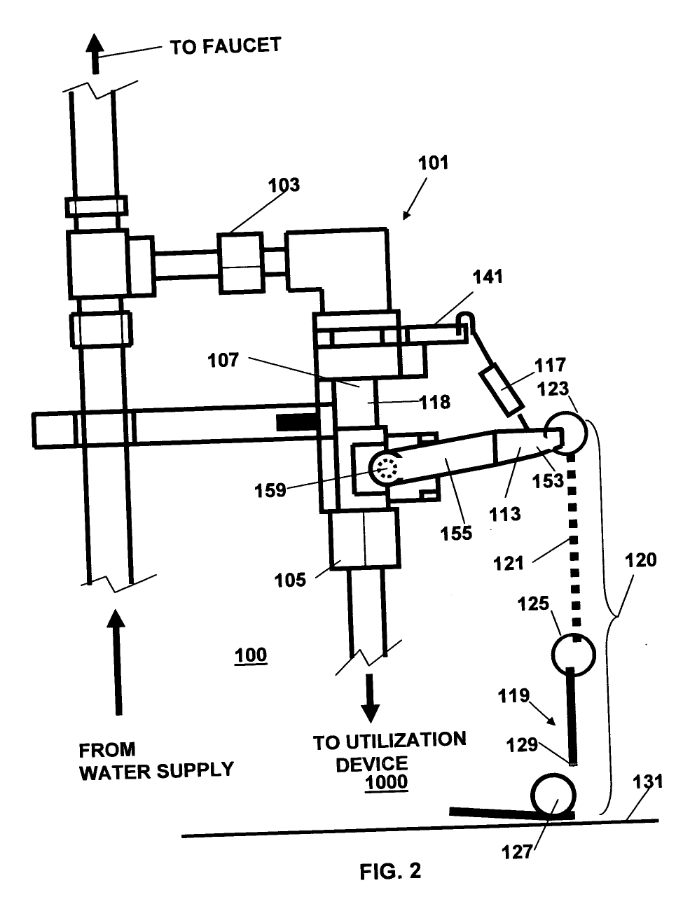

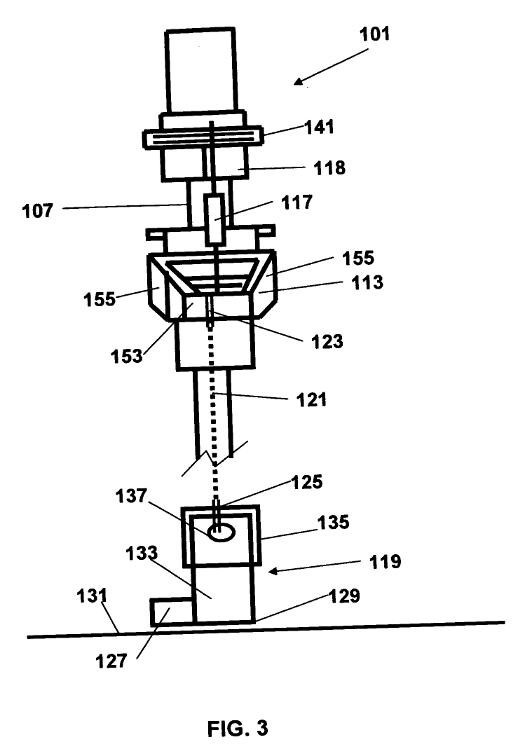

In the absence of leakage water on collection surface 131 Actuator 120 retains the valve member 109 in the first or open position in opposition to force provided by the bias member 117. Fluid responsive member 119 is tensioned as a result of the bias force provided by spring 117 and the retention force provided by retaining member 127. When leakage water is on collection surface 131, fluid responsive member 119 becomes weakened as it is subjected to the moisture. At some point, as fluid responsive member 119 becomes weakened to the point that the tension forces to which fluid responsive member is subjected causes fluid responsive member to separate. When fluid responsive member 119 separates as shown in FIG. 2, the bias force provided by spring 117 acting on lever 113 causes valve member 109 to be moved from the first or open position 114 to the second or closed position 116 such that valve member 109 engages valve seat 111 thereby sealing off valve assembly 101 to stop the flow of water from the water supply to the water utilization device 1000. Retaining member 127 is disposed in proximity to collection surface 131. The particular manner of affixing retaining member 127 in proximity to collection surface 131 may be any one of a number of well known manners of attachment.

In the illustrative embodiment of the invention, fluid responsive member 119 comprises a paper strip 133. Although a paper strip 133 is used, any other material that can withstand the tension provided by a spring 117 or other biasing element when dry and that separates or tears or dissolves when subjected to the tension when wet from the leakage fluid or water. Fluid responsive member 119 changes its physical condition in the presence of fluid such that when dry, it resists the force provided by the biasing element, and when wet the force provided by the biasing element overcomes the fluid responsive member.

A second portion of fluid responsive member 119 is adapted to engage a valve actuator. Fluid responsive member 119 at a second end includes a reinforcing member 135 that is affixed to paper strip 133 to prevent inadvertent tearing of paper strip 133 by connecting ring 125. A hole 137 through reinforcing member 135 is provided for receiving ring 125.

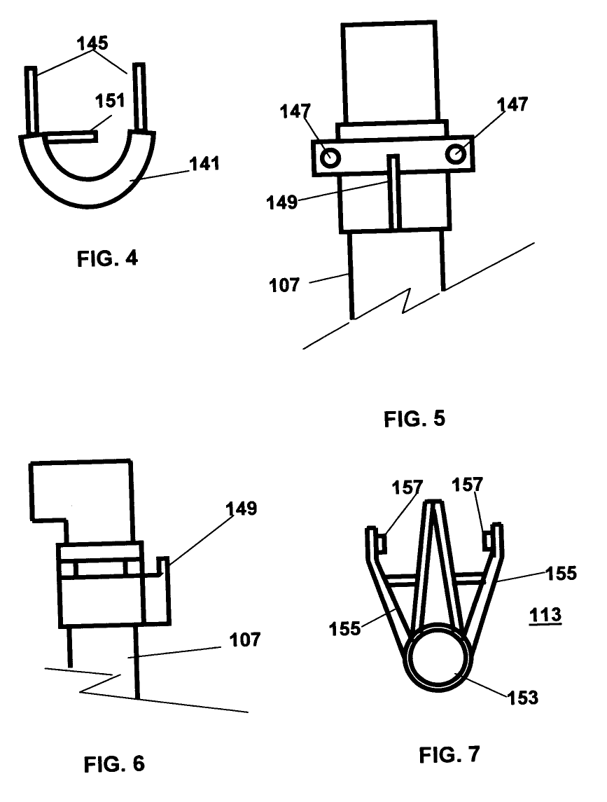

Spring 117 is attached to valve body 107 by means of attachment support 141, which is most clearly shown in FIG. 4. Attachment 141 includes a body portion 143 to which spring 117 attaches. Extending from body portion 143 are two elongate extensions or prongs 145. Prongs 145 are positioned and sized to engage support channels or holes 147 provided on valve body 107 as most clearly shown in FIG. 5. Valve body 107 also includes an integrally formed catch member 149, shown in FIGS. 5 and 6, that is sized and positioned or otherwise adapted to engage and return an engaging catch member 151 that is integrally formed on body portion 143. By providing attachment support 141 and the corresponding structure on valve body 107, a snap together construction is provided which makes assembly efficient and cost low.

Lever 113, shown in FIG. 7 includes an attachment portion 153 to which spring 117 attaches and which also is coupled to fluid responsive member 119. Lever 113 includes arms 155 each of which carries an integrally formed pin 157. Each of pins 157 engage a corresponding recess 159 on valve assembly 107. Lever 113 snaps into engagement with valve assembly 107.

Advantageously, the embodiment of the invention shown includes a valve body 107, support 141 and lever 113 all made of plastic material.

The illustrative embodiment of the invention is a water utilization system. It will be appreciated by those skilled in the art that the principles of the invention are applicable to other fluid systems, including, for example and not for limitation, alcohol, gasoline, glycol, hydraulic fluid, milk and other fluids.

The sensing element may change its physical characteristics or property such that when fluid dry it has sufficient tensile strength to oppose a bias force and when wet the change of physical characteristics of the sensing element is such that the bias force can cause the valve to change state. The change in physical characteristics may, by way of example include separation of a member, dissolving of the member, or stretching of the member in the presence of fluid

Still further, the sensing element of the invention may be utilized to change the state of an electrical or magnetic circuit rather than a valve. For example, the sensing element may be used to control a switch or a magnetic circuit rather than to move a valve between two positions.

The invention has been described in terms of various embodiments. It is not intended that the invention be limited to the illustrative embodiments. It will be apparent to those skilled in the art that various modifications and changes may be made to the embodiments without departing from the spirit or scope of the invention. Accordingly, it is intended that the invention be limited only by the claims appended hereto.

What is claimed is:

1. A valve for use with a fluid utilization device, comprising:
a valve assembly having a valve body, an inlet port, an outlet port, and a valve member movable between first and second positions, an element biasing said valve member to said second position;
an actuator coupled to said valve, said actuator comprising a fluid responsive member coupled to said biasing element to maintain said valve member in said first position in the absence of fluid, said fluid responsive member changing its physical properties in the presence of said fluid such that said fluid responsive member does not maintain said valve member in said first position and said biasing element causes said valve member to automatically move to said second position.

2. A water purification system, comprising:
a reverse osmosis system having an inlet coupleable to a water source; and
an automatic shut off valve disposed between said reverse osmosis system and said water source. said automatic shutoff valve comprising: a valve assembly having a valve body, an inlet port, an outlet port, and a valve member movable between first and second positions, an element biasing said valve member to said second position;
an actuator coupled to said valve, said actuator retaining said valve in said first position in opposition to force provided by said biasing element, said actuator comprising a fluid responsive member coupled to said biasing element to maintain said valve member in said first position in the absence of fluid, said fluid responsive member changing its physical condition in the presence of water such that said fluid responsive member releases said actuator such that said valve member automatically moves to said second position thereby preventing further flow of water from said water source.

3. A leak control arrangement, comprising:
a valve assembly comprising a valve movable between a first state and a second state, a bias element for exerting a first force urging said valve to said first state, and a fluid responsive member coupled to said valve and acting to restrain said valve in said first state in opposition to said first force, said fluid responsive member physically changing in responsive to fluid to allow said bias element to move said valve from said first state to said second state.

4. A leak control arrangement in accordance with claim 3, comprising:
a holding element adapted to hold said fluid responsive member in proximity to a fluid leak collection area.

5. A leak control arrangement in accordance with claim 4, wherein:
said fluid responsive member comprises a strip, said strip becoming weakened in the presence of fluid; and
said first force is such that when said strip becomes weakened, said first force is sufficient to cause said weakened strip to separate.

6. A leak control arrangement in accordance with claim 5, wherein:
said valve is a lever actuated valve.

7. A leak control arrangement in accordance with claim 6, wherein:
said bias member comprises a spring coupled to said lever.

8. A leak control arrangement in accordance with claim 7, wherein:
said bias element comprises a spring loaded lever.

9. A leak control arrangement, comprising:
a valve assembly having an inlet coupleable to source of water, an outlet coupleable to water utilization apparatus, a valve body, a valve seat, valve member disposed within said body and movable between an open position away from said valve seat and a closed position against said valve seat, a bias element for exerting a first force urging said valve to said first state; and
a single piece fluid responsive member coupled to said bias element and acting to restrain said valve member in said open position in opposition to said first force, said fluid responsive member separating in the presence of water to allow said bias element to move said valve member from said open position to said closed position.

10. A leak control arrangement in accordance with claim 9, comprising:
holding apparatus adapted to retain said fluid responsive member in proximity to a water leak collection area.

11. A leak control arrangement in accordance with claim 10, wherein:
said fluid responsive member comprises a strip, said strip becoming weakened in the presence of fluid; and
said first force being sufficient to cause said weakened strip to separate, but not being sufficient to cause said strip to separate when said strip is not weakened.

12. A leak control arrangement in accordance with claim 9, comprising:
a lever coupled to said valve member for moving said valve member between said open and closed positions, said bias element coupled to said lever.

13. A leak control arrangement in accordance with claim 12, wherein:
said bias member comprises a spring coupled to said lever and to said valve body.

14. A leak control arrangement in accordance with claim 13, comprising:
holding apparatus adapted to retain said fluid responsive member in proximity to a water leak collection area.

15. A leak control arrangement in accordance with claim 14, wherein:
said fluid responsive member comprises a strip, said strip becoming weakened in the presence of fluid; and
said first force being sufficient to cause said weakened strip to separate, but not being sufficient to cause said strip to separate when said strip is not weakened.

16. A leak control arrangement in accordance with claim 9, wherein:
said bias element comprises a spring loaded lever coupled to said valve member.

17. A water utilization system comprising:
a water utilization device;
a valve disposed upstream of said water utilization device, said valve comprising:
a valve assembly having a valve body, an inlet port, an outlet port, and a valve member movable between first and second positions, an element biasing said valve member to said first position; and
a fluid responsive member coupled to said biasing element to maintain said valve member in said first position in the absence of leakage water from said utilization device, said fluid responsive member being weakened in the presence of said leakage water such that said fluid responsive member is severed thereby allowing said bias force to automatically move said valve member to said second position.

18. A water utilization system in accordance with claim 17, wherein:
said water utilization device comprises a water conditioning system.

19. A water utilization system in accordance with claim 18, wherein:
said water conditioning system comprises a reverse osmosis unit.

20. A water utilization system in accordance with claim 17, wherein:
said water utilization device comprises a water heater.

21. A water utilization system in accordance with claim 17, wherein:
said water utilization device comprises a washing machine.

22. A water utilization system in accordance with claim 17, wherein:
said water utilization device comprises a boiler.

23. A water utilization system in accordance with claim 17, wherein:
said water utilization device comprises a hot water heating system.

24. A water utilization system, comprising:
water utilization apparatus having an input coupled to a water source;
a valve assembly disposed between said water source and said water utilization apparatus input, said valve assembly comprising a valve movable between a first state and a second state, a bias element for exerting a first force urging said valve to said second state; and
a water responsive member coupled to said valve and acting to restrain said valve in said first state in opposition to said first force, said water responsive member being responsive to water leakage from said water utilization apparatus to shear thereby allowing said bias element to move said valve from said first position to said second position.

25. A water utilization system, in accordance with claim 24, comprising:
a holding element adapted to hold said fluid responsive member in proximity to a leakage water collection area.

26. A water utilization system, in accordance with claim 25, wherein:
said water responsive member comprises a strip, said strip becoming weakened in the presence of water; and
said first force at a level such that when said strip becomes weakened, said first force is sufficient to cause said weakened strip to separate.

27. A water utilization system, in accordance with claim 26, wherein:
said valve is a lever actuated valve.

28. A water utilization system, in accordance with claim 27, wherein:
said bias member comprises a spring coupled to said lever.

29. A water utilization system, in accordance with claim 28, wherein:
said bias element comprises a spring loaded lever.

30. A water utilization system, comprising:
water utilization apparatus;
a valve assembly having an inlet coupled to source of water, an outlet coupled to said water utilization apparatus, a valve body, a valve seat, valve member disposed within said body and movable between an open position away from said valve seat and a closed position against said valve seat, a bias element for exerting a first force urging said valve to said closed position; and
a fluid responsive member coupled to said bias element and acting to restrain said valve member in said open position in opposition to said first force, said fluid responsive member separating in the presence of water leaked from said water utilization apparatus to allow said bias element to move said valve member from said open position to said closed position.

31. A water utilization system, in accordance with claim 30, comprising:
holding apparatus adapted to retain said fluid responsive member in proximity to a water leakage collection area.

32. A water utilization system in accordance with claim 31, wherein:
said fluid responsive member comprises a strip, said strip becoming weakened in the presence of water; and
said first force being sufficient to cause said weakened strip to separate, but not being sufficient to cause said strip to separate when said strip is not weakened.

33. A water utilization system in accordance with claim 30, comprising:
a lever coupled to said valve member for moving said valve member between said open and closed positions, said bias element coupled to said lever.

34. A water utilization system in accordance with claim 33, wherein:
said bias member comprises a spring coupled to said lever and to said valve body.

35. A water utilization system in accordance with claim 34, comprising:
holding apparatus adapted to retain said fluid responsive member in proximity to a water leak collection area.

36. A water utilization system in accordance with claim 35, wherein:
said fluid responsive member comprises a strip, said strip becoming weakened in the presence of water; and
said first force being sufficient to cause said weakened strip to separate, but not being sufficient to cause said strip to separate when said strip is not weakened.

37. A water utilization system in accordance with claim 30, wherein:
said bias element comprises a spring loaded lever coupled to said valve member.

38. A water utilization system in accordance with claim 30, wherein:
said water utilization device comprises a water conditioning system.

39. A water utilization system in accordance with claim 38, wherein:
said water conditioning system comprises a reverse osmosis unit.

40. A water utilization system in accordance with claim 30, wherein:
said water utilization device comprises a water heater.

41. A water utilization system in accordance with claim 30, wherein:
said water utilization device comprises a washing machine.

42. A water utilization system in accordance with claim 30, wherein:
said water utilization device comprises a boiler.

43. A water utilization system in accordance with claim 30, wherein:
said water utilization device comprises a hot water heating system.

44. A fluid responsive device for actuating a valve, comprising:
a strip of material that is resistant to separation when not in the presence of fluid and which is not resistant to separation when in the presence of fluid and subject to tension forces.

45. A fluid responsive device for actuating a valve in accordance with claim 44, wherein:
said strip comprises paper.

46. A fluid responsive device in accordance with claim 44, wherein:
a first portion of said strip is adapted to be retained proximate a fluid collection surface; and
a second portion of said strip being adapted to engage a valve actuator.
